(19) United States
(12) Patent Application Publication
(10) Pub. No.: US 2010/0027975 A1
(43) Pub. Date: Feb. 4, 2010

(54) PLAYBACK DEVICE AND PLAYBACK SYSTEM

(75) Inventors: Takao Sawabe, Tokorozawa-Shi (JP); Kazuo Kuroda, Tokorozawa-Shi (JP); Shoji Taniguchi, Tokorozawa-Shi (JP); Eiji Muramatsu, Tokorozawa-Shi (JP); Masahiro Kato, Tokorozawa-Shi (JP); Toshio Suzuki, Tokorozawa-Shi (JP); Akira Imamura, Tokorozawa-Shi (JP)

Correspondence Address: YOUNG & THOMPSON, 209 Madison Street, Suite 500, Alexandria, VA, 22314, US

(73) Assignee: Pioneer Corporation, Meguro-ku, Tokyo (JP)

(21) Appl. No.: 12/444,297

(22) PCT Filed: Oct. 25, 2006
(86) PCT No.: PCT/JP2006/321248

§ 371 Date: Apr. 3, 2009

(51) Int. Cl. H04N 7/26

(52) U.S. Cl. 386/124

(57) ABSTRACT

The present invention enables to limit playback of content recorded on a recording medium without fail. A playback system includes a recording medium 11 containing a plurality of pieces of actual data to play back a corresponding plurality of pieces of content, an information source 12 other than the recording medium 11, the information source containing at least one piece of playback control information among a plurality of pieces of playback control information required to play back the corresponding plurality of pieces of content, and a playback device that includes an acquiring unit 61 that acquires the playback control information from the information source 12, and a playback unit 61 and 62 that play back the content from the recording medium based on the playback control information acquired.

### TECHNICAL FIELD

The present invention relates to a playback device that plays back information from recording media such as an optical disk in which content such as images and sounds are recorded, and to a playback system.

### BACKGROUND ART

In related art, in playback devices of this type, as a technology to limit playback of content recorded on recording media such as a DVD, information is encrypted and recorded as represented by a content scramble system (CSS)(for example, refer to Patent Document 1).

### [Patent Document 1] JP-A-10-69755

### DISCLOSURE OF THE INVENTION

### Problems to be Solved

However, because the encryption technology of the related art such as the CSS is basically based only on information processing and calculation processing, there is a risk that the encryption may be broken. In other words, because the encryption technology performs the information processing and the calculation processing by using a predetermined key and based on a predetermined algorithm with respect to the information to be protected, if the key and the algorithm are revealed, the encryption can be broken. Therefore, it is not possible to reliably limit the playback of content recorded on the recording media by using such encryption technology.

In view of the above-described problems, the present invention provides a playback device and a playback system that can limit the playback of content recorded on a recording medium without fail.

### Means to Solve the Problems

A playback device of the present invention includes a playback unit that, from a recording medium containing actual data to play back content, plays back the content, and an acquiring unit that acquires file system information used to analyze a file structure of the recording medium from an information source other than the recording medium. The playback unit that plays back the content based on the file system information.

With this configuration, it is possible to playback the content, because the acquiring unit acquires the file system information from the information source. In other words, the playback unit cannot play back the content, unless the file system information is stored so as to be retrievable in the information source. Therefore, it is possible to limit the playback of the content recorded on the recording medium without fail, without storing the file system information in the information source so as to be retrievable.

The information source may be an optical disk, a magnetic disk, and a semiconductor memory (memory card) that can be loaded into the playback device, and a Web server connected to the playback device via a communication network.

In this case, it is preferable that the recording medium contains a plurality of pieces of actual data to play back a corresponding plurality of pieces of the content, and the information source stores therein at least one piece of file system information among a plurality of pieces of file system information required to play back the corresponding plurality of pieces of the content.

With this configuration, among the plurality of pieces of content contained in the recording medium, only the content whose corresponding file system information is stored so as to be retrievable in the information source can be played back. Therefore, by storing only a part of the plurality of pieces of file system information so as to be retrievable, it is possible to play back the part of content among the plurality of pieces of content, and limit the playback of the other content without fail.

In this case, it is preferable to further include a selecting unit that, among the plurality of pieces of the content contained in the recording medium, selects content to be played back based on an instruction from a user, a discriminating unit that discriminates whether to-be-selected file system information used to play back the selected content is included in the file system information acquired, and a notifying unit that, when it is discriminated that the to-be-selected file system information is not included, notifies the user that the to-be-selected file system information is not included.

With this configuration, it is possible to urge the user to take measures to turn the file system information required to play back content that the user desires to play back, into the state stored so as to be retrievable in the information source.

In this case, it is preferable that the information source contains expiration information that indicates an expiration date of the file system information, and the acquiring unit acquires the expiration information together with the file system information. It is also preferable to further include an expiration determining unit that, based on the expiration information, determines whether the file system information acquired has reached the expiration date, and the playback unit, when it is determined that the file system information has passed the expiration date, does not play back the content.

With this configuration, by setting the expiration date of the file system information from the expiration information, it is possible to easily set the expiration date until which the content can be played back.

A playback system of the present invention includes a recording medium containing a plurality of pieces of actual data to play back a corresponding plurality of pieces of content, an information source other than the recording medium, the information source containing at least one piece of file system information among a plurality of pieces of file system information required to play back the corresponding plurality of pieces of content, and a playback device including an acquiring unit that acquires the file system information from the information source, and a playback unit that plays back the content from the recording medium based on the file system information acquired.

With this configuration, among the plurality of pieces of the content contained in the recording medium, it is possible to only play back content whose corresponding file system information is stored so as to be retrievable in the information source. Therefore, by using the information source in which only a part of the plurality of pieces of file system information is stored so as to be retrievable, it is possible to play back the part of content from the plurality of contents, and limit the playback of the other contents without fail. Note that, in the above playback device, it is preferred that the content is encrypted using encrypted information, and the information source stores therein the encrypted information.

### BRIEF DESCRIPTION OF THE DRAWINGS

FIG. 1 is a configuration diagram of a playback system according to an embodiment of the present invention.

FIG. 2 is a schematic of a file structure of data recorded on either a first DVD or a second DVD of the playback system.

FIG. 3 is a schematic of patterns combined with data recorded on the first DVD and data recorded on the second DVD.

FIG. 4 is a block diagram of the playback system.

FIG. 5 is a flowchart of a series of playback processes in the playback system.

### REFERENCE NUMERALS

10 playback system
11 first DVD
12 second DVD
13 DVD player
61 reading unit
62 playback processing unit
64 system control unit
65 displaying unit

### BEST MODES FOR CARRYING OUT THE INVENTION

An exemplary embodiment of the present invention will be described below with reference to the accompanying drawings. A playback system according to the present embodiment, among a plurality of titles (content) such as videos and sounds recorded on a DVD, allows playback of only a title that a user has purchased.

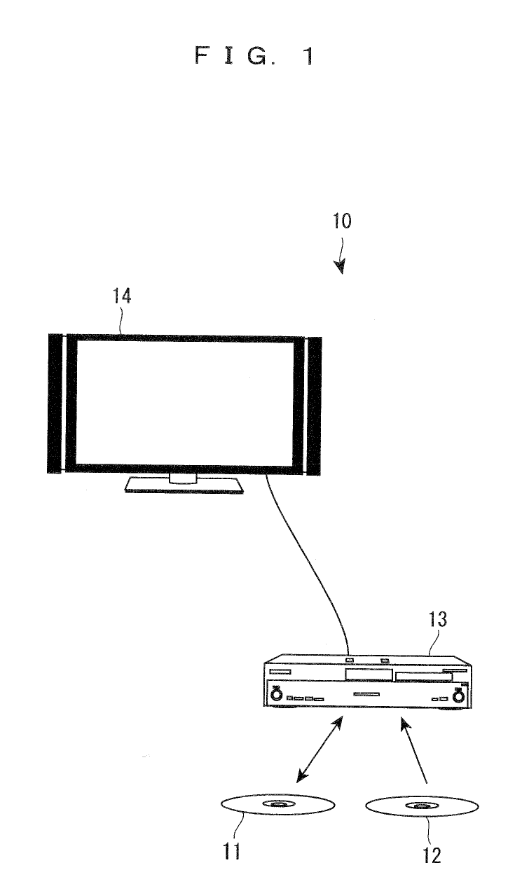

As shown in FIG. 1, a playback system 10 includes a first DVD 11 (such as DVD video), a second DVD 12 (such as DVD-RW), a DVD player 13 (playback device) that reads out the first DVD 11 and the second DVD 12, and an output monitor 14 that displays a video being played back.

In the first DVD 11, a plurality of pieces of actual data to play back a corresponding plurality of titles is recorded (stored) so that the DVD player 13 can read it out. In other words, a plurality of pieces (9 titles) of actual data to play back all the titles of a film series (for example, the first episode to the last ninth episode) is recorded in the first DVD 11. The first DVD 11 corresponds to a “recording medium” in the appended claims.

In the second DVD 12, among a plurality of pieces of playback control information required to play back the corresponding plurality of titles, at least one piece of playback control information is recorded (stored) so that the DVD player 13 can read it out. In other words, among the plurality of pieces (9 titles) of playback control information required to play back all the titles of the film, the playback control information that corresponds to the titles that the user has purchased (for example, a title #1 and a title #9) is recorded therein. The second DVD 12 corresponds to an “information source” in the appended claims.

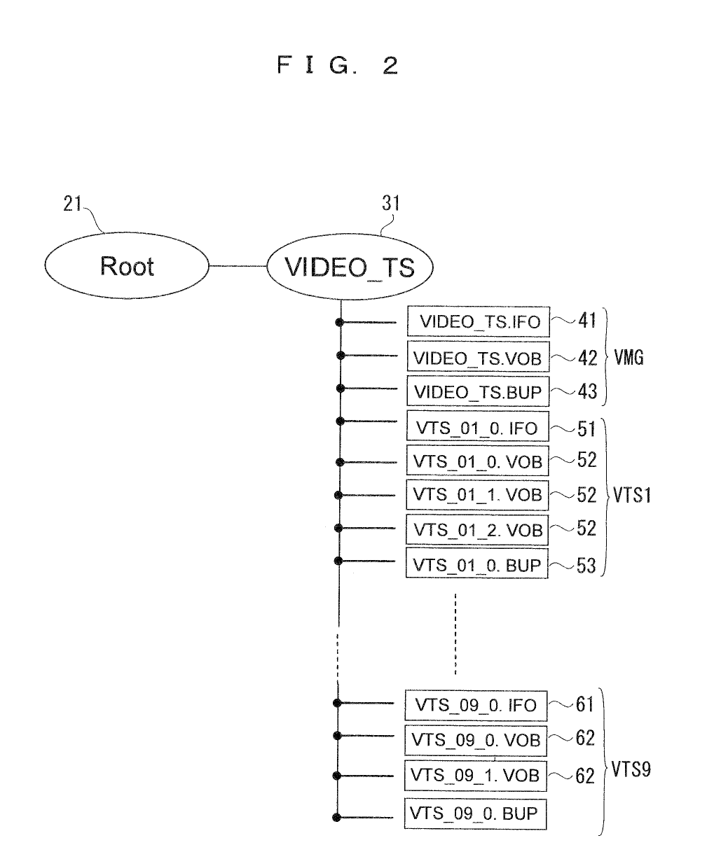

FIG. 2 is a schematic of a file structure of data recorded on either the first DVD 11 or the second DVD 12. A directory VIDEO_TS 31 is placed under a Root directory 21, and a video manager (VMG) and nine video title sets (VTS) (VTS 1 to VTS 9) are stored under the directory VIDEO_TS 31. The VMG is control information of the entire disk, and each VTS corresponds to one title.

The VMG is composed of the following three files, a VIDEO_TS.IFO 41, a VIDEO_TS.VOB 42, and a VIDEO_TS.BUP 43. The VIDEO_TS.IFO 41 is control information of the entire disk. The VIDEO_TS.VOB 42 is content for a title selection menu. The VIDEO_TS.BUP 43 is a backup file for the VIDEO_TS.IFO 41.

Each VTS is composed of the following files, a VTS_##_{—}0.IFO, a VTS_##_@.VOB, and a VTS_##_{—}0. BUP. For example, a VTS_{—}01_{—}0.IFO 51 is control information of a title #1. A VTS_{—}01_@.VOB 52 is actual data of the title #1. A VTS_{—}01_{—}0.BUP 53 is a backup file of the VTS_{—}01_{—}0.IFO 51. The symbol ## may take integer values from 01 to 09, and @ may take integer values from 1 to 9. Here, ## is given 01 to 09.

The actual data required to play back each title is the VTS_##_@.VOB, and logic information used to control the actual data is the VIDEO_TS.IFO 41 (common to all the titles) and the VTS_##_{—}0.IFO.

File system information used to analyze the file structure is recorded on either the first DVD 11 or the second DVD 12. In disk media such as DVD video, a universal disk format (UDF) based on the ISO 13346 standard is generally used as a file system.

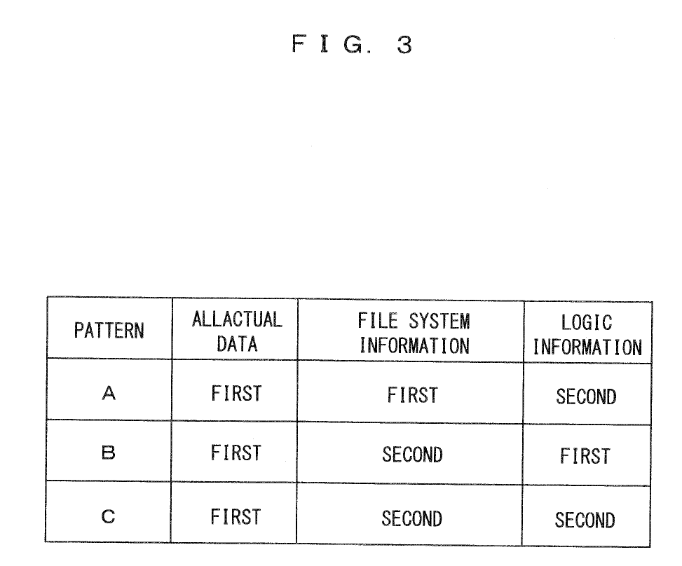

FIG. 3 is a schematic of patterns combined with data recorded on the first DVD 11 and data recorded on the second DVD 12. As shown in the diagram, at least one of the logic information and the file system information may be stored in the second DVD 12. For example, in case of pattern C, if a user has purchased a title #1 and a title #9, all the actual data for playback, in other words, the VTS_{—}01_@.VOB 52 or a VTS_{—}09_@.VOB 62 is recorded on the first DVD 11. On the other hand, the playback control information required to play back the title #1 and the title #9, in other words, the VMG, the file system information of the VTS 1 and the VTS 9, and the logic structure thereof (VIDEO_TS.IFO 41, VTS01_{—}0.IFO 51, and VTS_{—}09_{—}0.IFO 61) are recorded on the second DVD 12. A title key of encryption information for the title being purchased is recorded on the second DVD 12.

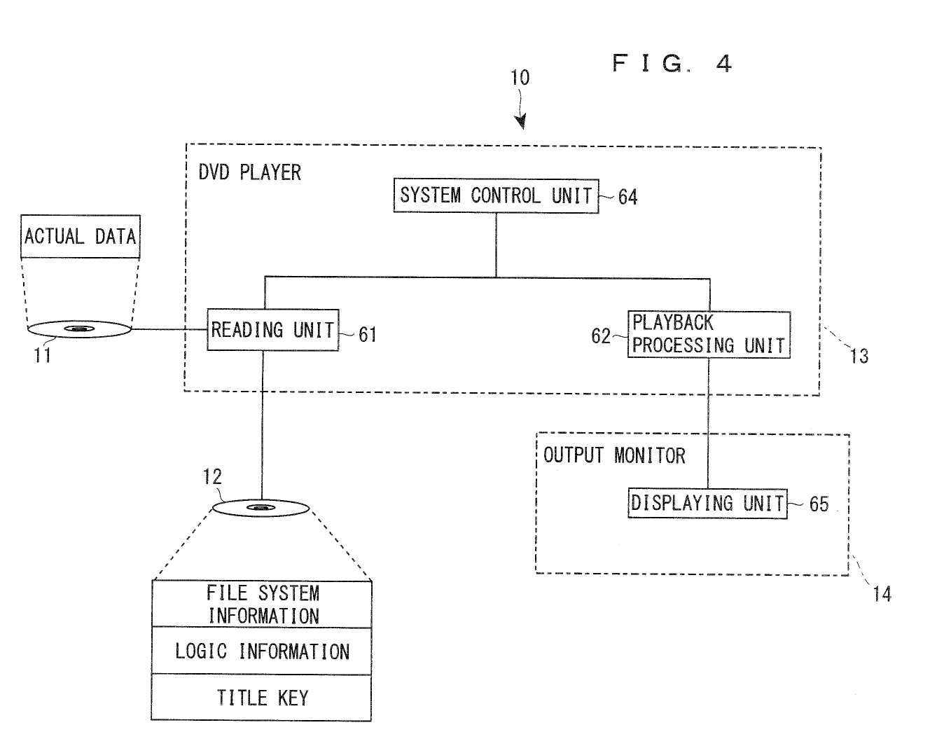

FIG. 4 is a block diagram of the playback system 10. The playback system 10 functionally includes a reading unit 61 that forms the DVD player 13, a playback processing unit 62, a system control unit 64, and a displaying unit 65 that forms the output monitor 14.

The reading unit 61 reads out data from the first DVD 11 and the second DVD 12. More specifically, the reading unit 61 includes a spindle motor that rotates the first DVD 11 and the second DVD 12, a pickup that reads out data, a tracking motor that moves the pickup, a servo system that controls each motor, and the like.

The playback processing unit 62 demodulates the read data, deciphers using the title key, decodes data compressed into an MPEG, and the like. The decoded video signal is output to the displaying unit 65. The system control unit 64 includes, for example, a CPU, and manages and controls the entire system.

In the appended claims, a playback unit mainly includes the reading unit 61 and the playback processing unit 62, an acquiring unit mainly includes the reading unit 61, a selecting unit mainly includes the system control unit 64 and the displaying unit 65, a discriminating unit mainly includes the system control unit 64, and a notifying unit mainly includes the displaying unit 65.

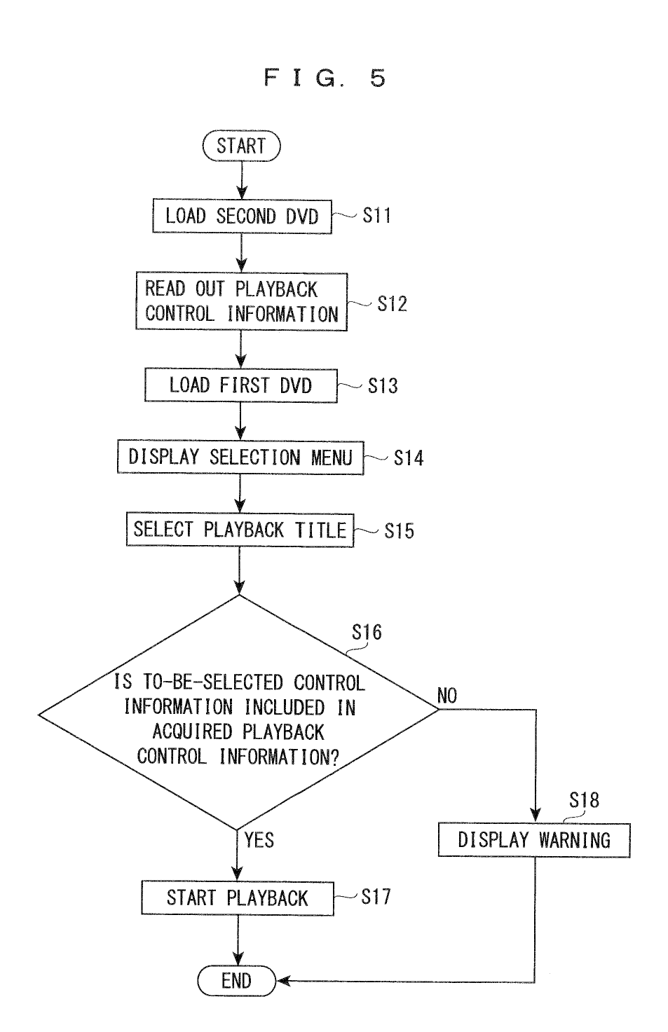

FIG. 5 is a flowchart of a series of playback processes in the playback system 10. When a user loads the second DVD 12 in the DVD player 13 (S11), the reading unit 61 reads out the playback control information therein (S12). Accordingly, the playback control information required to play back the title #1 and the title #9 is acquired. Then, the user loads the first DVD 11 in place of the second DVD 12 (S13). Subsequently, the displaying unit 65 displays a selection menu (S14). The system control unit 64 selects the title to be played back on the selection menu, based on an instruction from the user (S15).

Next, the system control unit 64 discriminates whether the playback control information (to-be-selected control information) to play back the selected title is included in the acquired playback control information (S16). For example, when the user instructs to play back the title #1, it is judged that the playback control information of the title #1 is included in the acquired playback control information (Yes at S16). Subsequently, based on the playback control information and the title key of the acquired title #1, the playback processing unit 62 performs data processing such as demodulating, deciphering, and decoding, and starts to play back (S17). When the user instructs to play back the title #2, it is judged that the playback control information of the title #2 is not included in the acquired playback control information (No at S16), and the displaying unit 65 displays a warning that the title #2 is not purchased (S18).

In this manner, with the playback system 10 according to the present embodiment, among nine titles recorded on the first DVD 11, only the title #1 and the title #9 of which the corresponding playback control information is stored so as to be retrievable in the second DVD 12 can be played back. Therefore, among the playback control information of nine titles, by using the second DVD 12 in which only the playback control information that corresponds to the title #1 and the title #9 is stored so as to be retrievable, it is possible to play back the title #1 and the title #9 among the nine titles. At the same time, it is also possible to limit the playback of the other titles #2 to #8 without fail.

It is also possible to set an expiration date to the playback control information. In other words, in the second DVD 12, expiration information that indicates the expiration date of the playback control information is recorded. The reading unit 61 acquires the expiration information with the playback control information. The system control unit 64 (expiration determining unit), based on the expiration information, determines whether the playback control information has not reached the expiration date. When it is judged that the playback control information has passed the expiration date, the playback processing unit 62 does not play back the title. The expiration date may be set to each title (each content).

The playback system 10 can be applied to a video rental system. For example, assuming that a customer goes to a rental shop and decides to rent only the first episode from all the titles of a film series. The rental shop gives the customer the first DVD 11 in which actual data of all the titles of a film series is recorded, records the playback control information only for the first episode (title #1), among the playback control information of all the titles, onto the second DVD 12 that the customer has brought (or owned by the shop), and gives the second DVD 12 to the user. The customer can only view the first episode by using the DVD player 13 at home. If the customer wishes to rent the subsequent second episode, he/she goes to the rental shop again and has the playback control information of the second episode recorded onto the second DVD 12. In other words, the second DVD 12 is updated. Therefore, it is preferable to use a disk of rewritable type for the second DVD 12.

Particularly in the video rental system, as described above, it is preferable to set the expiration date (e.g., in three days) of the playback control information. With this, it is possible to urge the user to return the first DVD 11 and the second DVD 12.

In the present embodiment, the second DVD 12 is used as an information source in which the playback control information is readably recorded. However, it is also possible to use other recording media such as a memory card. It is also possible to acquire (download) the playback control information from a Web server via the Internet. In this case, the acquiring unit includes an interface connected to the Internet.

Contents to be played back are not limited to films, for example, may be articles in an encyclopedia. More specifically, in the first DVD 11, actual data of all the articles in the encyclopedia is recorded, and the playback control information of the article selected based on an instruction (purchase) from a user is downloaded from a server. With this, the user may only purchase the playback control information for the article he/she wishes to playback. In other words, there is no need to purchase the entire encyclopedia, and the encyclopedia can be available at low cost.

1-6. (canceled)

7. A playback device comprising:
a playback unit that, from a recording medium containing actual data to play back content, plays back the content; and
an acquiring unit that acquires file system information used to analyze a file structure of the recording medium from an information source other than the recording medium, wherein
the playback unit plays back the content based on the file system information.

8. The playback device according to claim 7, wherein
the recording medium contains a plurality of pieces of the actual data to play back a corresponding plurality of pieces of the content, and
the information source stores therein at least one piece of file system information among a plurality of pieces of the file system information required to play back the corresponding plurality of pieces of the content.

9. The playback device according to claim 8, further comprising:
a selecting unit that, among the plurality of pieces of the content contained in the recording medium, selects content to be played back based on an instruction from a user;
a discriminating unit that discriminates whether to-be-selected file system information used to play back the selected content is included in the file system information acquired; and
a notifying unit that, when it is discriminated that the to-be-selected file system information is not included, notifies the user that the to-be-selected file system information is not included.

10. The playback device according to claim 7, wherein
the information source contains expiration information that indicates an expiration date of the file system information, and
the acquiring unit acquires the expiration information together with the file system information,
the playback device further comprises an expiration determining unit that, based on the expiration information, determines whether the file system information acquired has reached the expiration date, and
the playback unit, when it is determined that the file system information has passed the expiration date, does not play back the content.

11. A playback system comprising:
a recording medium containing a plurality of pieces of actual data to play back a corresponding plurality of pieces of content;
an information source other than the recording medium, the information source containing at least one piece of file system information among a plurality of pieces of file system information required to play back the corresponding plurality of pieces of content; and
a playback device including an acquiring unit that acquires the file system information from the information source, and a playback unit that plays back the content from the recording medium based on the file system information acquired.

12. The playback device according to claim 7, wherein
the content is encrypted using encrypted information, and
the information source stores therein the encrypted information.
